(19) United States
(12) Patent Application Publication
(10) Pub. No.: US 2011/0002553 A1
(43) Pub. Date: Jan. 6, 2011

(54) COMPRESSIVE CODING DEVICE AND DECODING DEVICE

(75) Inventors: Yukinari NISHIKAWA, Hamamatsu-shi (JP); Mitsuhiro HONME, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA CORPORATION, Hamamatsu-shi (JP)

(21) Appl. No.: 12/824,926

(22) Filed: Jun. 28, 2010

(30) Foreign Application Priority Data
Jul. 1, 2009 (JP) 2009-156991

(51) Int. Cl. G06K 9/36

(52) U.S. Cl. 382/233; 382/238

(57) ABSTRACT

A compressive coding device is constituted of a coordinates conversion process converting original pixel data of the RGB presentation into pixel data of the YCbCr presentation, an irreversible conversion process, and a reversible compressive coding process. In the irreversible conversion process, the components Cb and Cr of pixel data are thinned out by way of a reduction process and subsequently interpolated based on the component Y of pixel data by way of an expansion process, while some bits of pixel data are reduced by way of a quantization process. The reversible compressive coding process performs a predictive coding process and a variable-length coding process on each pixel data selected in a raster-scanning sequence, thus producing compressive coded data. This makes it possible to decode both reversible compressive coded data and irreversible compressive coded data in units of lines.

### BACKGROUND OF THE INVENTION

1. Field of the Invention

The present invention relates to compressive coding devices which perform reversible/irreversible compressive coding on visual data and to decoding devices which decode compressive coded data so as to reproduce visual data.

The present application claims priority on Japanese Patent Application No. 2009-156991 (Filing Date: Jul. 1, 2009), the content of which is incorporated herein by reference.

2. Description of the Related Art

Line-buffer visual processing LSI (Large Scale Integration) devices are typical examples of visual processing devices used for game devices. This type of visual processing devices performs a series of procedures in which a sprite pattern memory stores visual data of sprites (i.e. independent graphic objects) representing game characters; visual data are read from the sprite pattern memory in conformity with the progression of a game; visual data are edited via rotation and scaling (i.e. expansion and reduction) and written into line buffers in units of horizontal scanning lines; thereafter, images and graphics are displayed on the screen of a liquid crystal display (LCD) based on the stored contents of line buffers.

The product values of visual processing devices are highly dependent upon the sprite rendering performance (namely, the number of dots or pixels of a sprite which can be rendered on each line on screen). The number of dots of a sprite which can be rendered on each line of a screen depends upon the amount of visual data which can be processed in each unit of time; hence, the sprite rendering performance partly depends upon the amount of data transferred between a sprite pattern memory and a visual processing device. Since the present technology is limited in the amount of data transferred between sprite pattern memory and visual processing devices, it is difficult to achieve adequate sprite rendering performance. In order to achieve the adequate sprite rendering performance irrespective of the limited amount of data transferred between a sprite pattern memory and a visual processing device, it is necessary to perform compressive coding on visual data of sprites (e.g. compressive coding performed in units of frames) so as to produce compressive coded data, which are stored in the sprite pattern memory. This reduces the amount of data transferred for per each sprite.

The compressive coding technology used for visual data is generally classified into reversible compressive coding and irreversible compressive coding. The reversible compressive coding is a combination of predictive coding and variable-length coding (e.g. Huffman coding), for example. The irreversible compressive coding employs orthogonal transformation, for example. The reversible compressive coding is able to perfectly restore original visual data based on compressive coded data but unable to obtain a high compression factor. The irreversible compressive coding is able to obtain a high compression factor but unable to perfectly restore original visual data based on compressive coded data. In general, visual processing devices incorporated in game devices employ the reversible compressive coding. This is because game characters are created by graphics designers who place a high value on design so that original visual data should be perfectly reproduced on screen.
Patent Document 1: Japanese Patent Application Publication No. H04-175066

Conventionally, this type of visual processing devices has been used to display still pictures. Recently, this type of visual processing devices has often been used to display simple moving pictures composed of still pictures on screen. Even though moving pictures composed of still pictures are displayed on screen, human eyes cannot recognize a small degradation of picture quality due to the movements of the pictures. In the case of moving pictures composed of still pictures, it is preferable to adopt an irreversible compressive coding algorithm, thus reducing the amount of external memory needed and the amount of data being transferred. For this reason, it is necessary to develop a visual processing device and a visual processing algorithm, which is able to decode both reversible compressive coded data (e.g. visual data of still pictures) and irreversible compressive coded data (e.g. visual data of moving pictures composed of still pictures). The above visual processing device will have a high market value and a high product value. Conventionally, some visual processing algorithms performing visual processing in units of frames are able to handle both the reversible compressive coding and the irreversible compressive coding. However, no visual processing algorithm performing visual processing in units of lines have been developed to handle both of the reversible compressive coding and the irreversible compressive coding.

### SUMMARY OF THE INVENTION

It is an object of the present invention to provide a compressive coding device for performing visual processing in units of lines and to provide a decoding device which is able to decode both reversible compressive coded data and irreversible compressive coded data.

A compressive coding device of the present invention is constituted of a coordinates conversion section, an irreversible conversion section, and a reversible compressive coding section. The coordinates conversion section converts pixel data of the RGB presentation composed of three primary color components R, G, B into pixel data of the YCbCr presentation composed of three color components Y, Cb, Cr. In the irreversible conversion section, a reduction process is performed to thin out a prescribed part of pixel data with respect to at least one of three color components Y, Cb, Cr, and an expansion process is performed to interpolate the components Cb and Cr of pixel data so as to restore the prescribed part of pixel data based on the remaining part of pixel data which is not thinned out. In the reversible compressive coding section, a predictive coding process is performed to calculate a predictive value of each pixel data selected in a raster-scanning sequence based on other pixel data positioned close to the selected pixel data; a predictive error is calculated as the difference between the predictive value and the actual value of each pixel data; and variable-length coding is performed on the predictive error so as to produce compressed coded data. It is possible to implement the above sections by way of a compressive coding program executed by a computer or the like.

The compressive coding device or the compressive coding program has the reversible compressive coding section implementing the combined procedure of the predictive coding process and the variable-length coding process, thus producing reversible compressive coded data which can be perfectly restored as original visual data prior to the compressive coding. Herein, thinning-out and interpolating calculations preceding the reversible compressive coding process are irreversible calculations; hence, the compressive coding device or the compressive coding program entirely performs the irreversible compressive coding on visual data. Irreversible compressive coded data can be decoded by way of a variable-length decoding process, an inverse predictive coding process, and an inverse coordinates conversion process, thus reproducing original pixel data of the RGB presentation.

It is noted that in particular, the reversible compressive coding section is similar to the reversible compressive coding section employed in the conventional visual processing device having a line-buffer configuration. The present invention enables a single decoding device to decode both irreversible compressive coded data and reversible compressive coded data as follows.

A sprite pattern memory stores both reversible compressive coded data and irreversible compressive coded data (which are produced by the compressive coding device of the present invention) in advance. The decoding device or visual processing device decodes reversible compressive coded data read from the sprite pattern memory in accordance with the conventional decoding procedure sequentially carrying out the variable-length decoding process and the inverse predictive coding process. Alternatively, it sequentially performs the variable-length decoding process, the inverse predictive coding process, and the inverse coordinates conversion process on irreversible compressive coded data read from the sprite pattern memory, thus reproducing original pixel data of the RGB presentation. In Patent Document 1 teaching the irreversible compressive coding technology employing the orthogonal transformation, quantization, and coding, an original picture signal (representing an original picture prior to compressive coding) is converted into a quasi-picture signal by way of the orthogonal transformation, quantization, inverse quantization, and inverse orthogonal transformation. When the difference between the original picture signal and the quasi-picture signal is small, the quasi-picture signal is substituted for the original picture signal and subjected to irreversible compressive coding, thus minimizing the degradation of the picture quality due to the irreversible compressive coding. However, the technology of Patent Document 1 cannot allow a single decoding device to decode both reversible compressive coded data and irreversible compressive coded data.

Preferably, the irreversible conversion section performs the reduction process and the expansion process such that the predictive error becomes zero alternately with respect to adjacent pixel data which are adjacently aligned on each horizontal scanning line on screen. This increases the probability that the predictive error of the predictive coding process includes a consecutive-0's portion. In the variable-length coding process employing zero run-length coding, it is possible to increase the compression factor of visual data as the number of “0” bits consecutively appearing in the predictive error becomes larger.

Preferably, the irreversible conversion section performs a quantization process for reducing bits on pixel data already subjected to the reduction process and the expansion process or pixel data not subjected to the reduction process or the expansion process. In addition, the irreversible conversion section outputs a quantization-mode signal representing the type of pixel data subjected to the quantization process and the number of reduced bits. The quantization process further increases the compression factor of visual data.

A decoding device is designed to handle compressive coded data, which are produced by way of the predictive coding process and the variable-length coding process, in accordance with a quantization-mode signal representing the type of pixel data subjected to the quantization process and the number of reduced bits owing to the quantization process. The decoding device includes a reversible decoding section, an inverse quantization section, and an inverse coordinates conversion section as follows.

The reversible decoding section decodes compressive coded data into pixel data of the YCbCr presentation by way of the variable-length decoding process and the inverse predictive coding process. The inverse quantization section interpolates the number of reduced bits included in the type of pixel data designated by the quantization-mode signal with respect to pixel data output from the reversible decoding section. The inverse coordinates conversion section reproduces original pixel data of the RGB presentation based on pixel data of the YCbCr presentation passing through the inverse quantization section.

### BRIEF DESCRIPTION OF THE DRAWINGS

These and other objects, aspects, and embodiments of the present invention will be described in more detail with reference to the following drawings.

FIG. 1 is a block diagram showing a compressive coding/decoding system including a compressive coding device and a decoding device according to a preferred embodiment of the present invention.

FIG. 2A shows a reduction process included in an irreversible conversion process of the compressive coding device.

FIG. 2B shows an expansion process included in the irreversible conversion process of the compressive coding device.

FIG. 3 is an illustration explaining a predictive coding process for calculating a predictive value and a predictive error with respect to each pixel.

FIG. 4 shows an example of predictive errors which are calculated with respect to pixels of matrixes horizontally aligned.

FIG. 5 shows the relationship between input data and output data with respect to a predictive error conversion process performing sign bit inversion on the predictive error.

FIG. 6 shows the relationship between input data and output data with respect to the predictive error conversion process performing the sign bit inversion on the predictive error of six bits (except for a sign bit).

FIG. 7 shows a conversion table which a variable-length coding process refers to when converting the predictive error into a variable-length code.

FIG. 8A is a graph showing variants of compression factors over frames of moving pictures including a human character and objects.

FIG. 8B is a graph showing variants of compression factors over frames of moving pictures including animations.

FIG. 8C is a graph showing variants of compression factors over frames of moving pictures regarding a landscape.

FIG. 9 is a block diagram showing the constitution of a visual processing LSI device according to the preferred embodiment of the present invention.

FIG. 10 shows two types of compressive coding information with respect to reversible compressive coding and irreversible compressive coding.

### DESCRIPTION OF THE PREFERRED EMBODIMENT

The present invention will be described in further detail by way of examples with reference to the accompanying drawings.

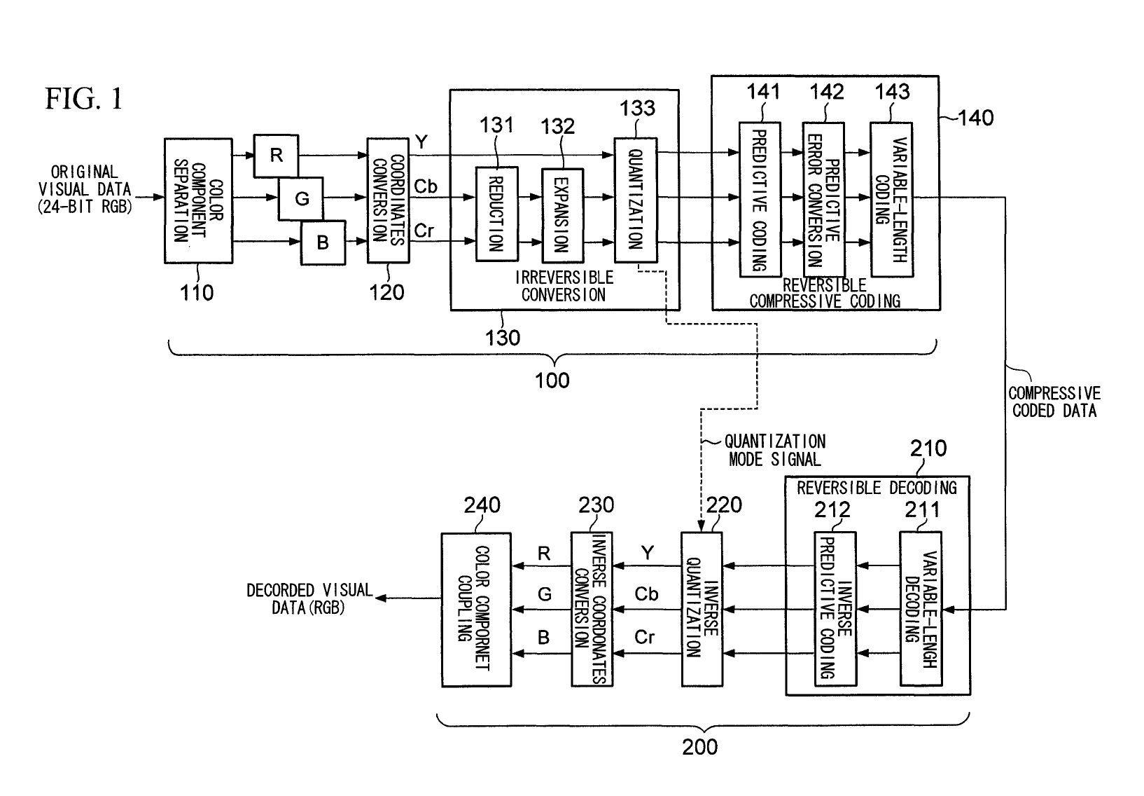

FIG. 1 is a block diagram showing the constitution of a compressive coding/decoding system performing irreversible compressive coding on visual data, which are constituted of a compressive coding device 100 and a decoding device 200 according to the preferred embodiment of the present invention. The compressive coding device 100 performs irreversible compressive coding on visual data so as to produce irreversible compressive coded data. Visual data are sets of pixel data composed of three color components R, G, and B, representing pixels constituting an entire screen image. In the present embodiment, the brightness (or intensity) of each color component is represented in a range from 0 to 255 (i.e. 8-bit data), so that each pixel data composed of three color components is represented by 3×8=24 bits. In the compressive coding/decoding system of FIG. 1, irreversible compressive coded data produced by the compressive coding device 100 are stored in a storage media such as a CD-ROM (Compact Disk Read-Only Memory), which are distributed to users or consumers. Alternatively, irreversible compressive coded data are downloaded to users or consumers via telecommunication lines such as the Internet. The decoding device 200 decodes irreversible compressive coded data output from the compressive coding device 100, thus reproducing original visual data.

The compressive coding device 100 is constituted of, for example, a digital signal processor (DSP). An irreversible compressive coding program implementing the irreversible compressive coding is installed in the compressive coding device 1 in advance. In accordance with the irreversible compressive coding program, the compressive coding device 100 performs irreversible compressive coding which is an essential feature of the present invention. The compressive coding device 100 is constituted of a color component separation process 110, a coordinates conversion process 120, an irreversible conversion process 130, and a reversible compressive coding process 140. The present embodiment implements these processes by way of the software; but this is not a restriction. For example, it is possible to configure the color component separation process 110, the coordinates conversion process 120, the irreversible conversion process 130, and the reversible compressive coding process 140 by means of a color component separation circuit, a coordinates conversion circuit, an irreversible conversion circuit, and a reversible compressive coding circuit respectively, wherein these electronic circuits are combined together to form the hardware of the compressive coding device 100.

The color component separation process 110 disassembles original visual data (rendered in the RGB presentation) into color components R, G, and B. The R component of pixel data is 8-bit data representing the brightness of the red color of each pixel; the G component of pixel data is 8-bit data representing the brightness of the green color of each pixel; and the B component of pixel data is 8-bit data representing the brightness of the blue color of each pixel.

The coordinates conversion process 120 converts pixel data from the RGB presentation to the YCbCr presentation, in other words, it changes the primary colors R, G, B into Y, Cb, Cr colors. Specifically, the coordinates conversion process 120 converts the components R, G, B of pixel data into the components Y, Cb, Cr of pixel data in accordance with a mapping rule (1). The reason why the present embodiment needs to perform the above conversion will be discussed later.

Y=0.257×R+0.504×G+0.098×B+16

Cb=−0.148×R−0.291×G+0.439×B+128

Cr=0.439×R−0.368×G−0.071×B+128 (1)

The irreversible conversion process 130 is a pre-processing intended to improve the compression factor in the reversible compressive coding process 140. The irreversible conversion process 130 is constituted of a reduction process 131, an expansion process 132, and a quantization process 133.

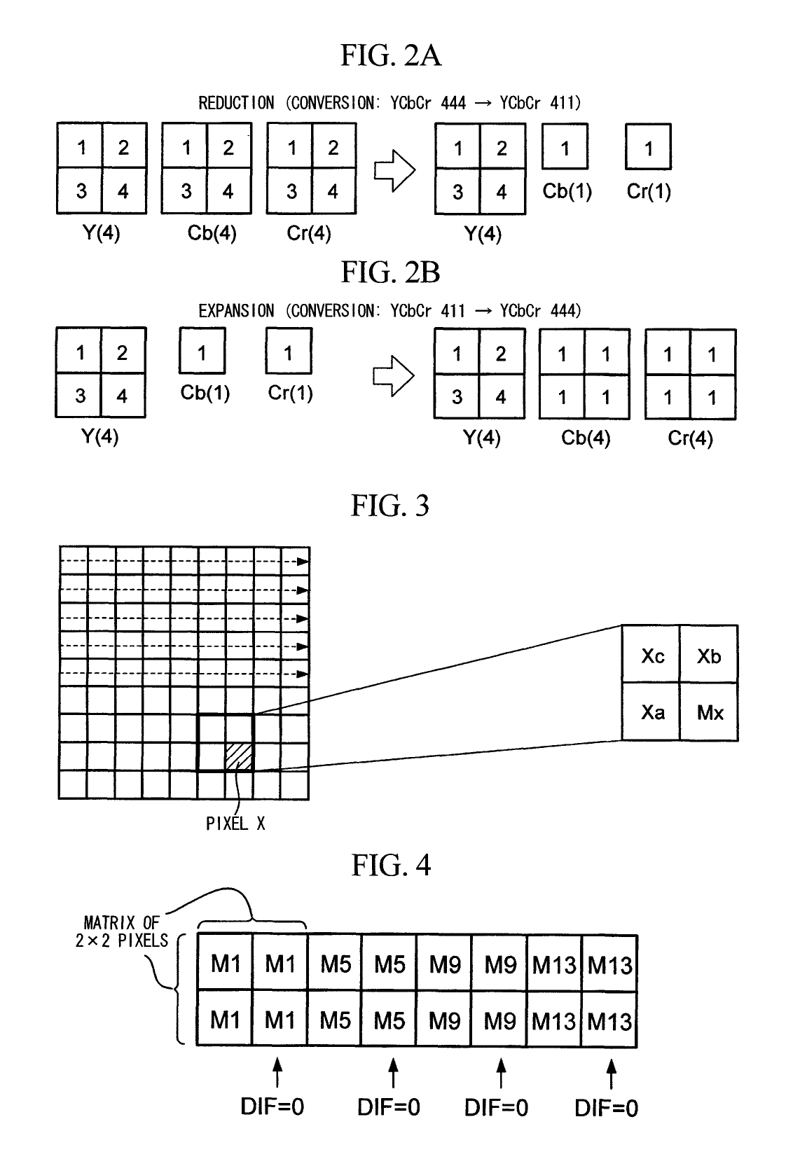

The reduction process 131 and the expansion process 132 handle two components Cb and Cr among three components Y, Cb, and Cr of pixel data output from the coordinates conversion process 120. The reduction process 131 subdivides pixel data configured of Cb and Cr components in units of matrixes each configured of 2×2 pixels as shown in FIG. 2A. The reduction process 131 eliminates three pixels from each matrix configured of four pixels except for the upper-left pixel with respect to pixel data of Cb and Cr components, thus converting “YCbCr 444” (representing all of Y, Cb, and Cr components holding four pixels) into “YCbCr 411” (representing that the Y component still holds four pixels while the Cb and Cr components each hold one pixel). In other words, the reduction process 131 thins out three pixels for every four pixels. The expansion process 131 interpolates thinned-out pixels using the remaining pixel (i.e. the upper-left pixel within four pixels of each matrix, which is not thinned out in the reduction process 131) as shown in FIG. 2B. In an aspect for the improvement of the compression factor of visual data, it is better to perform compressive coding on pixel data of YCbCr 411 (see FIG. 2A) rather than pixel data of YCbCr 444 (see FIG. 2B). Nonetheless, the present embodiment is designed such that the expansion process 132 converts pixel data of YCbCr 411 into pixel data of YCbCr 444. The reason why the present embodiment employs the above conversion will be discussed later in connection with the decoding device 200. In this connection, the irreversible conversion process 130 does not perform the reduction process 131 and the expansion process 132 on the Y component of pixel data because the Y component represents the brightness of each pixel; hence, the picture quality must be significantly degraded when the Y component is thinned out. In addition, the irreversible conversion process 130 is carried out after the coordinates conversion process 120 which converts pixel data from the RGB presentation into the YCbCr presentation in order to prevent the degradation of the picture quality due to the reduction process 131, the expansion process 132, and the quantization process 133.

The quantization process 133 handles any one of or all of the Y, Cb, and Cr components of pixel data so as to reduce the number of bits configuring each pixel data constituting visual data. The quantization process 133 is carried out with reference to a quantization-mode table, for example, whose stored contents are shown in Table 1. The quantization-mode table can be embedded in the irreversible compressive coding program, or it can be stored in the compressive coding device 100 independently of the irreversible compressive coding program. The quantization-mode table (see Table 1) stores quantization coefficients (i.e. a Y-component quantization coefficient, a Cb-component quantization coefficient, and a Cr-component quantization coefficient), each representing the number of bits reduced in each component, in connection with quantization modes, i.e. seven modes with values “0” to “6” (where Mode=0 disuses the quantization process 133). In the quantization process 133, quantization coefficients are read from the quantization-mode table in response to a preset mode (or a mode indicated by a quantization mode signal given from an external device), so that the corresponding components of pixel data are subjected to rightward logical shifting by numbers of bits corresponding to quantization coefficients. Thus, it is possible to achieve quantization in response to the predetermined mode.

TABLE 1

| | Y-component | Cb-component | Cr-component |
|---|---|---|---|
| | Quantization | Quantization | Quantization |
| Mode | Coefficient | Coefficient | Coefficient |
| 0 | 0 | 0 | 0 |
| 1 | 1 | 0 | 0 |
| 2 | 1 | 1 | 1 |
| 3 | 2 | 0 | 0 |
| 4 | 2 | 1 | 1 |
| 5 | 2 | 2 | 2 |
| 6 | 3 | 2 | 2 |

In the case of MODE=1, pixel data is subjected to 1-bit rightward logical shifting so as to reduce one bit with respect to only the Y-component. In the case of MODE=2, pixel data is subjected to 1-bit rightward logical shifting so as to reduce one bit with respect to all the Y-component, Cb-component, and Cr-component. In the present embodiment, pixel data passing through the irreversible conversion process 130 are subjected to the reversible compressive coding process 140 so as to output irreversible compressive coded data. Thereafter, irreversible compressive coded data are subjected to decoding in the decoding device 200. The reversible compressive coding process 140 is a typical example of reversible calculations combining the predictive coding and the variable-length coding. Since the reversible compressive coding process 140 is preceded by the irreversible conversion process 130 configured of irreversible calculations, the compressive coding device 100 performs irreversible calculations overall. As shown in FIG. 1, a quantization-mode signal representing a quantization mode of the quantization process 133 is transmitted from the compressive coding device 100 to the decoding device 200. The quantization-mode signal is used in an inverse quantization process 220, which is the inverse of the quantization process 133, in the decoding device 200.

The reversible compressive coding process 140 is constituted of a predictive coding process 141, a predictive error conversion process 142, and a variable-length coding process 143. As shown in FIG. 3, pixels constituting visual data subjected to compressive coding are selected in a raster-scanning sequence, wherein a pixel X is picked up and subjected to the predictive coding process 141, for example. The predictive coding process 141 calculates a predictive value Mx with respect to the pixel X in light of its adjacent pixels; then, it calculates the difference between the predictive value Mx and an actual value of the pixel X as a predictive error X−Mx.

Specifically, the predictive coding process 141 calculates the predictive value Mx according to the following algorithm. First, three adjacent pixels are picked up around the pixel X, i.e. a left-side pixel Xa (whose data is also denoted as “Xa”), an upper pixel Xb (whose data is also denoted as “Xb”), and an upper-left pixel Xc (whose data is also denoted as “Xc”). A maximum value “max(Xa,Xb,Xc)” among the pixel data Xa, Xb, and Xc is subjected to a decision as to whether or not Xc=max(Xa,Xb,Xc). When Xb<Xa on the condition of Xc=max(Xa,Xb,Xc), the predictive coding process 141 substitutes Xb for Mx. When Xa<Xb on the condition of Xc=max(Xa,Xb,Xc), the predictive coding process 141 substitutes Xa for Mx. If not Xc=max(Xa,Xb,Xc), a minimum value “min(Xa,Xb,Xc)” among the pixel data Xa, Xb, and Xc is subjected to a decision as to whether or not Xc=min(Xa,Xb,Xc). When Xb>Xa on the condition of Xc=min(Xa,Xb,Xc), the predictive coding process 141 substitutes Xa for Mx. If neither Xc=max(Xa,Xb,Xc) and Xc=min(Xa,Xb,Xc), in other words, when Xc>min(Xa,Xb,Xc) and Xc<max(Xa,Xb,Xc), the predictive coding process 141 sets Mx=Xa+Xb−Xc as the predictive value Mx. Thereafter, the predictive coding process 141 calculates the predictive error X−Mx (i.e. the difference between the predictive value Mx and the actual value of the pixel X).

Prior to the predictive coding process 141 calculating predictive errors, the irreversible conversion process 130 produces a matrix configured of four pixel data in which the components Cb and Cr are set to the same value. As shown in FIG. 4, a plurality of matrixes each configured of four pixel data having the same value are horizontally aligned. In the matrix, the predictive error of a lower-right pixel is normally set to zero. A detailed explanation is omitted herefrom, however, it is generally said that the sizes of compressive coded data become smaller (in other words, the compression factor becomes higher) as more and more pixels whose predictive values are zero consecutively appear on screen.

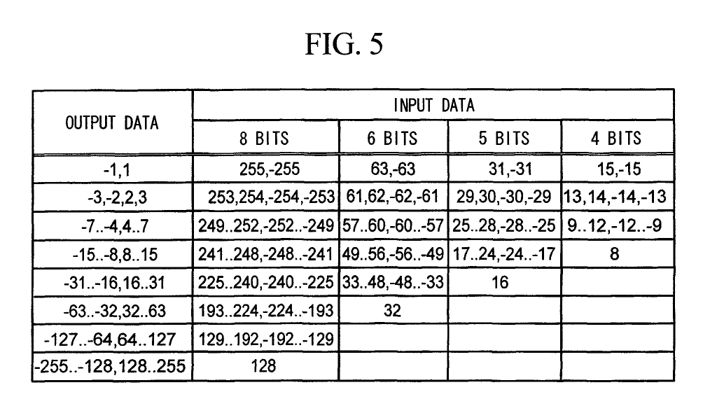

The predictive error conversion process 142 performs sign bit inversion on the predictive error (calculated in the predictive coding process 141) when the sign bit inversion reduces the absolute value of the predictive error. The contents of the predictive error conversion process 142 differ with respect to the number of bits constituting the predictive error, i.e. the number of bits included in each of pixel data constituting visual data subjected to compressive coding. FIG. 5 shows the relationship between input data and output data with respect to the predictive error conversion process 142, wherein input data represent the predictive error whose number of bits (except for a sign bit) is changed with 8 bits, 6 bits, 5 bits, and 4 bits. FIG. 5 shows only the relationship between certain input data, whose absolute value decreases via the sign bit inversion, and the corresponding output data. That is, FIG. 5 does not show the relationship between input data, whose absolute value does not decrease via the sign bit inversion, and the corresponding output data.

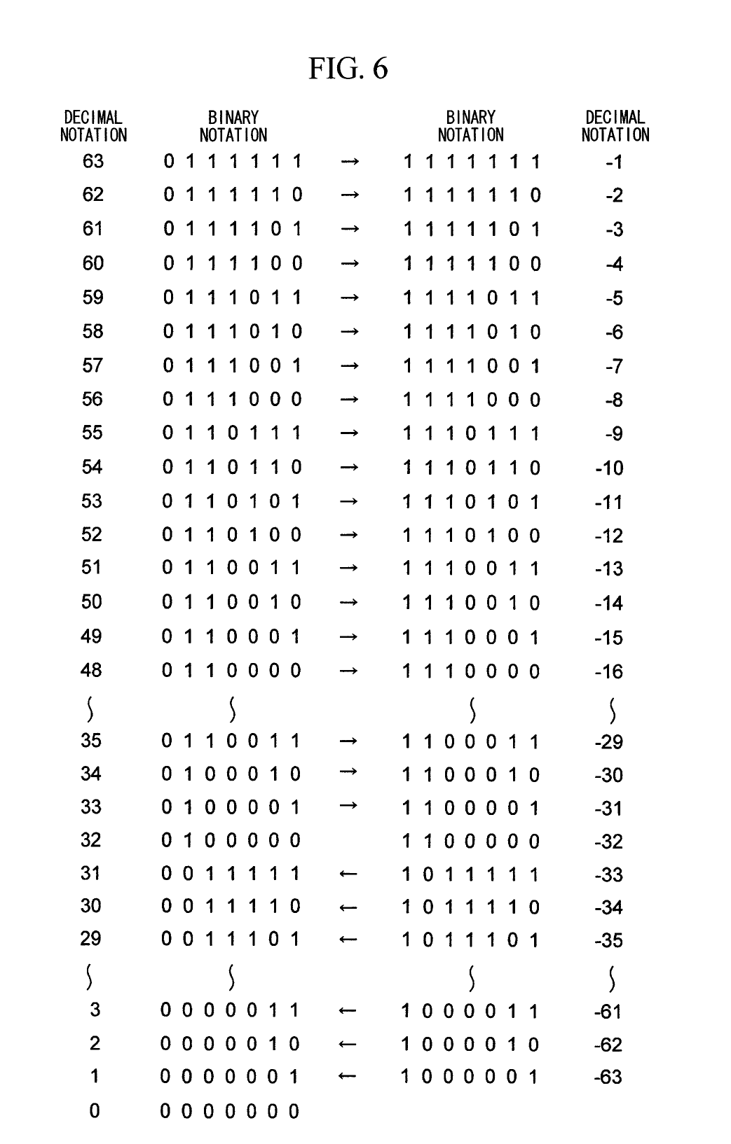

FIG. 6 shows the relationship between input data and output data with respect to the predictive error conversion process 142 receiving the predictive error of six bits (except for a sign bit), wherein arrows designate directions of conversion. In the present embodiment, negative values of binary data (representing components of pixel data, predictive errors, etc.) are represented in two's complement. For example, the absolute value of a 6-bit predictive error (except for its sign bit) decreases to be lower than the original absolute value by way of the sign bit inversion when the original absolute value is 32 or more. For this reason, the predictive error conversion process 142 needs to perform the sign bit inversion on the “positive” predictive error whose absolute value is 2⁶⁻¹=32 or more. In addition, the “negative” predictive error whose absolute value is 32 or more (i.e. a negative value of −32 or lower) decreases to be lower than the original absolute value by way of the sign bit inversion. For this reason, the predictive error conversion process 142 needs to perform the sign bit inversion on the “negative” predictive value whose absolute value is 32 or more. Similar operation is performed with respect to other predictive errors each consisting of a different number of bits. In the case of the predictive error of 8 bits, for example, the predictive error whose absolute value is 2⁸⁻¹=128 or more is selectively subjected to the sign bit inversion. In the case of the predictive error of 5 bits, the predictive error whose absolute value is 2⁵⁻¹=16 or more is selectively subjected to the sign bit inversion. In the case of the predictive error of 4 bits, the predictive error whose absolute value is 2⁴⁻¹=8 or more is selectively subjected to the sign bit inversion.

The variable-length coding process 143 performs variable-length coding on the predictive error passing through the predictive error conversion process 142. As described above, the predictive coding process 141 calculates the predictive error with respect to the pixel X which is selected from among pixels constituting visual data subjected to compressive coding in a raster-scanning sequence. In the present embodiment, predictive errors which are sequentially calculated in the raster-scanning sequence in the predictive coding process 141 are sequentially subjected to the predictive error conversion process 142 and the variable-length coding process 143 in an order of calculations, thus sequentially converting them into variable-length codes. A set of variable-length codes is assembled into irreversible compressive coded data which are output from the compressive coding device 100.

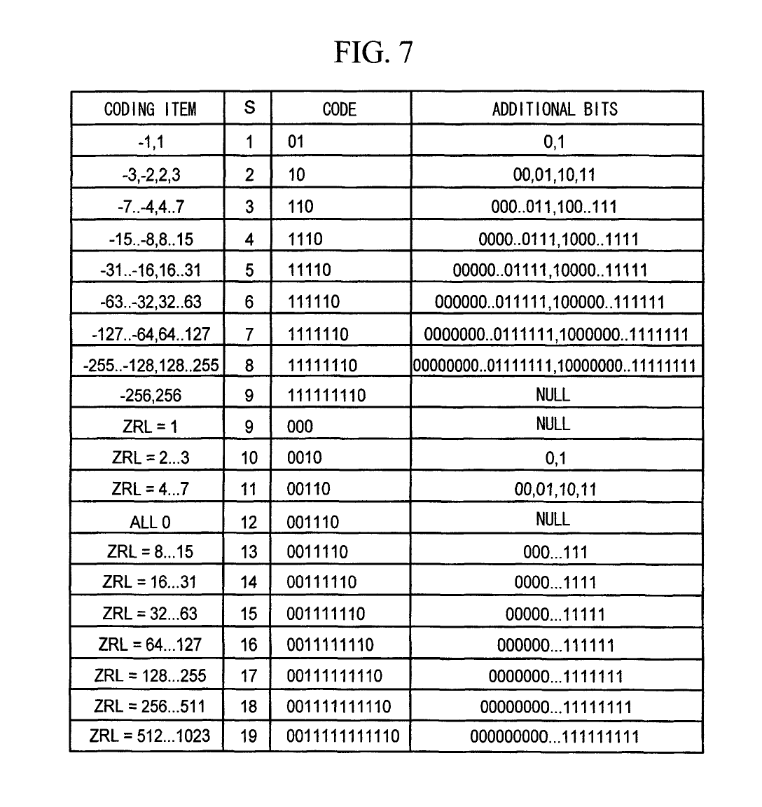

FIG. 7 shows a conversion table which the variable-length coding process 143 refers to when converting predictive errors into variable-length codes. Similar to the quantization-mode table, the conversion table can be embedded in the irreversible compressive coding program, or it can be stored in the compressive coding device 100 independently of the irreversible compressive coding program. In the conversion table of FIG. 7, “CODING ITEM” denotes the predictive error passing through the predictive error conversion process 142, and “S” denotes a group number assigned to variable-length codes having the same length. A single variable-length code is constituted of a code and an additional bit, wherein the code serves as identification information discriminating a group of each variable-length code from other groups. The additional bit serves as identification information discriminating each variable-length code from other variable-length codes within a group of variable-length codes having a certain code.

Within coding items (i.e. predictive errors whose absolute value is not zero), predictive errors having a smaller absolute value are converted into variable-length codes having a shorter length, consisting of a code and an additional bit, in accordance with the conversion table of FIG. 7. For example, two coding items “−1” and “1” both of which have the same absolute value “1” are converted into variable-length codes belonging to the group number S=1 assigned with a code “01”, wherein they are discriminated using additional bits “0” and “1” respectively. Four coding items “−3”, “−2”, “2”, and “3” whose absolute values are “2” or “3” are converted into variable-length codes belonging to the group number S=2 assigned with a code “10”, wherein they are discriminated using additional bits “00”, “01”, “10”, and “11” respectively. Similarly, other coding items are subclassified into groups having consecutive absolute values, wherein groups having a higher absolute value are assigned with codes having a longer length. Except for the group number S=9 whose absolute value is “256”, the number of coding items included in each group becomes larger with respect to groups having a higher absolute value; hence, the length of additional bits discriminating coding items correspondingly becomes longer. In the present embodiment, the maximum number of bits constituting the predictive error is set to eight bits (except for a sign bit); hence, “−256” and “256” represent overflow states. In this connection, the coding items “−256” and “256” are each assigned with the same code “111111110” and converted into variable-length codes having no additional bits.

With respect to coding items “ZRL” (i.e. Zero Run Length) whose absolute value is zero, consecutive-0s portions are converted into variable-length codes. For example, a coding item ZRL=1 whose absolute value is “1” is converted into a variable-length code belonging to the group number S=9 assigned with a code “000”. Two coding items ZRL=2, 3 whose absolute values are “2” or “3” are converted into variable-length codes belonging to the group number S=10 assigned with a code “0010”, wherein they are discriminated using additional bits “0” and “1” respectively. Four coding items ZRL=4, 5, 6, 7 whose absolute values range from “4” to “7” are converted into the group number S=11 assigned with a code “00110”, wherein they are discriminated using additional bits “00”, “01”, “10”, and “11”. Similarly, other coding items “ZRL” are subclassified into groups having consecutive values of ZRL, wherein groups having a higher value of ZRL are assigned with codes having a longer length. The number of coding items “ZRL” included in each group becomes larger with respect to groups having a higher value of ZRL; hence, the length of additional bits discriminating coding items “ZRL” correspondingly becomes longer. The present embodiment assumes an “ALL0” state regarding the predictive error in order to improve the compression factor. In the ALL0 state, the predictive error is zero with respect to a presently designated pixel, and all the predictive errors are zero with respect to other pixels linearly aligned with the presently designated pixel. The ALL0 state is designated by a code “001110”, so that the corresponding coding items are converted into variable-length codes having no additional bits. The present embodiment performs the reduction process 131 and the expansion process 132 on pixel data with respect to the components Cb and Cr, so that predictive errors calculated for pixels aligned in a horizontal scanning line are alternately set to zero. Therefore, the consecutive-0s length likely becomes longer. For this reason, the present embodiment is designed to efficiently perform variable-length coding using ZRL, thus improving the compression factor.

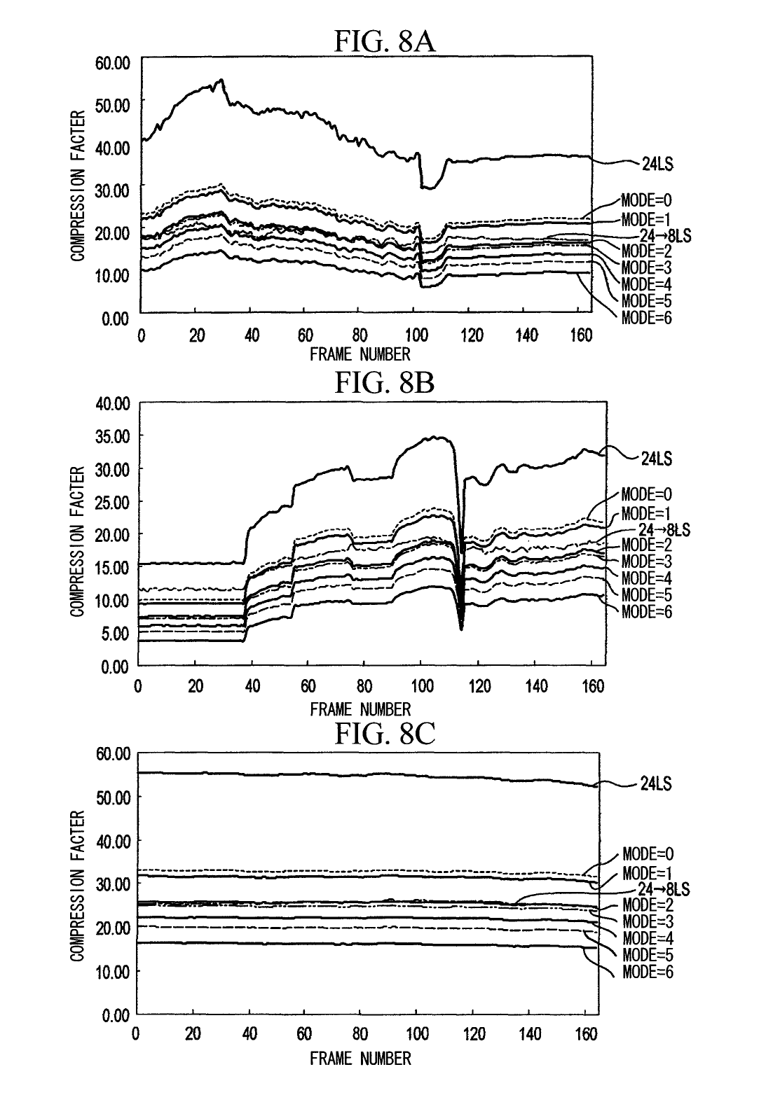

FIGS. 8A to 8C show the evaluation results of the performance of the compressive coding device 100 by use of various samples of moving pictures, e.g. 24-bit full-color moving pictures in which the brightness (or intensity) regarding each of the three color components R, G, and B of pixel data is represented using eight bits, so that twenty-four bits are used in total). Specifically, FIGS. 8A to 8C show variants of compression factors during the progression of moving pictures in connection with a first procedure in which 24-bit full-color moving pictures are subjected to reversible compressive coding (which is denoted as “24LS” in each graph), a second procedure in which 24-bit full-color moving pictures are subjected to irreversible compressive coding at various quantization modes (i.e. MODE=0 to MODE=6), and a third procedure in which 24-bit full-color moving pictures are reduced in color into 8-bit moving pictures and subjected to reversible compressive coding (which is denoted as “24→8LS” in each graph). FIG. 8A shows variants of compression factors with respect to moving pictures including human characters and other objects, in which a human character riding a motorcycle and running on roads, for example. FIG. 8B shows variants of compression factors with respect to animation pictures. FIG. 8C shows variants of compression factors with respect to moving pictures of a landscape, in which fishes are swimming around a coral reef, for example. In FIGS. 8A, 8B, and 8C, the vertical axis represents the compression factor, and the horizontal axis represents the frame number denoting each of frames constituting moving pictures.

FIGS. 8A, 8B, and 8C clearly show that the compression factor remains constant in all frames of moving pictures in respect of the second procedure of MODE=2 in which the components Y and Cb of pixel data are each reduced by one bit (see Table 1) and the third procedure (see “24→8LS”) in which 24-bit full-color moving pictures are reduced in color into 8-bit moving pictures and subjected to reversible compressive coding. Herein, the evaluation standard is set to the third procedure in which 24-bit full-color moving pictures are reduced in color into 8-bit moving pictures and subjected to reversible compressive coding, because conventional displays (e.g. liquid crystal displays) employing 8-bit gradation (i.e. 256 colors) of color presentation are likely involved in the above color reduction. The evaluation results prove that no degradation of the picture quality is found in the second procedure employing the irreversible compressive coding of the present embodiment irrespective of the quantization of MODE=2. This proves that the compressive coding device 100 of the present embodiment is able to achieve the same compression factor as the third procedure employing 24-bit/8-bit color reduction (converting 24-bit moving pictures into 8-bit moving pictures) plus reversible compressive coding while minimizing the degradation of the picture quality. The third procedure employing 24-bit/8-bit color reduction plus reversible compressive coding requires color palette data; hence, the present embodiment employing irreversible compressive coding of MODE=2 achieves a higher compression factor compared to that of the third procedure considering the entire size of compressive coded data including color palette data.

Next, the decoding device 200 will be described in detail. Similar to the compressive coding device 100, the overall function of the decoding device 200 is realized according to a decoding program or the like installed in a digital signal processor (DSP) or a computer. The decoding device 200 performs a reversible decoding process 210, the inverse quantization process 220, an inverse coordinates conversion process 230, and a color component coupling process 240 according to the decoding program. The present embodiment realizes these processes by way of the software; but this is not a restriction. For example, it is possible to configure the reversible decoding process 210, the inverse quantization process 220, the inverse coordinates conversion process 230, and the color component coupling process 240 by means of a reversible decoding circuit, an inverse quantization circuit, an inverse coordinates conversion circuit, and a color component coupling circuit respectively, wherein these electronic circuits are combined together to form the hardware of the decoding device 200.

The reversible decoding process 210 is the inverse of the reversible coding process 140 and is constituted of a variable-length decoding process 211 and an inverse predictive coding process 212. The variable-length decoding process 211 is the inverse of the variable-length coding process 143. The variable-length coding process 211 reproduces predictive errors (prior to the variable-length coding process 143) from variable-length codes composed of additional bits and codes with reference to the same conversion table used in the variable-length coding process 143. The inverse predictive coding process 212 is the inverse of the predictive coding process 141. Based on predictive errors reproduced in the variable-length decoding process 211, the inverse predictive coding process 212 converts irreversible compressive coded data into pixel data having components Y, Cb, and Cr corresponding to predictive errors. Detailed operation of the inverse predictive coding process 212 will be described with respect to the situation where the inverse predictive coding process 212 receives the predictive error of the pixel data X on the condition that three pixel data Xa, Xb, and Xc have been already decoded as shown in FIG. 3 with respect to one of components Y, Cb, and Cr. In this situation, the inverse predictive coding process 212 calculates the predictive value Mx of the pixel data X based on the pixel data Xa, Xb, and Xc according to an algorithm similar to that of the predictive coding process 141. The predictive value Mx is added to the predictive error so as to produce the “entire” pixel data X. By performing the reversible decoding process 210 on irreversible compressive coded data output from the predictive coding device 100, it is possible to perfectly restore original pixel data prior to the reversible compressive coding process 140 of the compressive coding device 100. In other words, it is possible to perfectly restore pixel data of the YCbCr presentation passing through the quantization process 133.

According to the mapping rule (1), pixel data composed of components Y, Cb, and Cr have a positive value; hence, pixel data passing through the quantization process 133 has a value of zero or more. On the precondition that pixel data composed of components Y, Cb, and Cr prior to the predictive coding process 141 has a positive value, the inverse predictive coding process 212 recognizes a data portion (except for a sign bit) of the addition result of the predictive error and the predictive value Mx as the decoding result of pixel data. For this reason, the inverse predictive coding process 212 reproduces the same pixel data based on the predictive error irrespective of a sign bit (where “0” indicates a positive value, while “1” indicates a negative value) as long as the data portion (except for a sign bit) of input pixel data remains the same. The compressive coding device 100 needs to perform the predictive error conversion process 142 owing to the above feature of predictive coding in which a sign bit “1”/“0” of the predictive error does not affect the decoding result, since it is necessary to reduce the absolute value of the coding item (i.e. the predictive error) in the variable-length coding process 143 and to reduce the length of a variable-length code after conversion, in other words, it is necessary to reduce the amount of compressive coding data, thus improving the compression factor. A concrete example of this operation will be described below.

Suppose that pixel data is configured of six bits (except for a sign bit) with respect to each of components Y, Cb, and Cr, and the predictive error is configured of six bits; pixel data X is set to “59d” (where “d” denotes a decimal notation), the predictive value is set to “10d”, and the predictive error is set to “49d=0110001b” (where “b” denotes a binary notation, and a first bit “0” is a sign bit representing a positive value) with reference to the conversion table of FIG. 7. When the compressive coding device 100 does not perform the predictive error conversion process 142, for example, the variable-length coding process 143 converts the predictive error “49d” into a 12-bit variable length code composed of a code of the group number S=6 “111110” and additional bits “110001” with reference to the conversion table of FIG. 7. In the decoding device 200, the variable-length decoding process 211 reproduces the predictive error “49d” from the variable-length code output from the compressive coding device 100. The inverse predictive coding process 212 performs a binary addition according to an equation (2) on the predictive value “10d=0001010b” and the reproduced predictive error “49d=0110001b”, thus reproducing the original pixel data X of “59d”.

0001010b+0110001b=0111011b=59d (2)

In contrast to the above operation, the decoding device 200 cooperates with the compressive coding device 100 including the predictive error conversion process 142 as follows.

According to FIG. 6, the predictive error “49d” is converted into “0110001b” (where a first bit denotes a sign bit). Changing the sign bit from “0” to “1” yields “1110001b”, which corresponds to “−15d” in decimal notation. The absolute value of “−15d” is smaller than the absolute value of “49d”. In the compressive coding device 100, the predictive error conversion process 142 converts the predictive error into “1110001b=−15d” by inverting the sign bit. Subsequent to the predictive error conversion process 142, the variable-length coding process 143 converts the sign-bit inverted predictive error of “1110001b=−15d” into an 8-bit variable-length code which is constituted of additional bits “0000” and a code “1110” belonging to the group number S=4 with reference to the conversion table of FIG. 7. In the decoding device 200, the variable-length decoding process 211 decodes the variable-length code into the sign-bit inverted predictive error of “1110001b=−15d”. Subsequent to the variable-length decoding process 211, the inverse predictive coding process 212 adds the predictive value of “10d=0001010b” to the decoded predictive error of “1110001b=−15d” according to an equation (3).

0001010b+1110001b=1111011b (3)

The inverse predictive coding process 212 negates the sign bit “1” in the addition result of “1111011b” so as to produce pixel data X of “111011b=59d”. That is, decoded pixel data is determined based on the predictive value and the predictive error (except for its sign bit). In the predictive coding device 100 of the present embodiment, when the absolute value of the predictive error decreases due to the sign bit inversion of the predictive error, the predictive error conversion process 142 performing the sign bit inversion on the predictive error is followed by the variable-length coding process 143, thus reducing the length of the variable-length code constituting irreversible compressive coded data.

It is crucial that the reversible decoding process 210 is essentially equivalent to the foregoing decoding process for decoding pixel data subjected to reversible compressive coding according to a compressive coding algorithm implementing both the predictive coding and the variable-length coding. For this reason, it is possible to employ a conventional decoding circuit performing the reversible decoding process 210, which decodes pixel data subjected to reversible compressive coding according to the compressive coding algorithm implementing both the predictive coding and the variable-length coding. In other words, the decoding device 200 of the present embodiment is able to perform a first decoding operation for decoding pixel data subjected to irreversible compressive coding and a second decoding operation for decoding pixel data subjected to reversible compressive coding. If the compressive coding device 100 skips the expansion process 132, the decoding device 200 needs to perform an additional operation equivalent to the expansion process 132. In this case, it is impossible to use the conventional decoding circuit, which needs to be modified to cope with the above situation. In the case of a visual processing LSI device having a line-buffer configuration which performs decoding in units of lines, it is necessary to perform a complex expansion process spanning over lines, for which it is necessary to modify the decoding circuit in a complicated manner. In contrast, the second embodiment allows the compressive coding device 100 to perform the expansion process 132; this makes it possible to configure the decoding device 200 by directly using the decoding circuit for decoding visual data subjected to reversible compressive coding according to the compressive coding algorithm implementing both the predictive coding and the variable-length coding. This is the reason why the present embodiment incorporates the expansion process 132 in the compressive coding device 100.

The inverse quantization process 220 is the inverse of the quantization process 133, wherein it interpolates reduced bits of pixel data which are reduced in the quantization process 133. The quantization-mode signal, which is transmitted from the compressive coding device 100 to the decoding device 200, represents pixel data whose bits are reduced in the quantization process 133 and the number of reduced bits. In response to the quantization-mode signal, the inverse quantization process 220 interpolates pixel data with respect to components Y, Cb, and Cr according to Table 2.

TABLE 2

| Quantization- | | | |
|---|---|---|---|
| Mode | | | |
| Signal | Y-Component | Cb-Component | Cr-Component |
| 0 | Y[7:0] | Cb[7:0] | Cr[7:0] |
| 1 | Y[6:0], Y[6] | Cb[7:0] | Cr[7:0] |
| 2 | Y[6:0], 7[6] | Cb[6:0], Cb[6] | Cr[6:0], Cr[6] |
| 3 | Y[5:0], Y[5:4] | Cb[7:0] | Cr[7:0] |
| 4 | Y[5:0], Y[5:4] | Cb[6:0], Cb[6] | Cr[6:0], Cr[6] |
| 5 | Y[5:0], Y[5:4] | Cb[5:0], Cb[5:4] | Cr[5:0], Cr[5:4] |
| 6 | Y[4:0], Y[4:2] | Cb[5:0], Cb[5:4] | Cr[5:0], Cr[5:4] |

In the case of MODE=1, for example, the quantization process 133 of the compressive coding device 100 reduces one bit from Y-component pixel data, which is thus cast into seven bits (e.g. Y[6:0] in Table 2). In contrast, the inverse quantization process 220 of the decoding device 200 adds the reduced bit (e.g. Y[6]), which is a first bit of Y-component pixel data, as a last bit of Y-component pixel data, so that pixel data is reproduced in eight bits.

The inverse coordinates conversion process 230 subsequent to the inverse quantization process 220 is the inverse of the coordinates conversion process 120, wherein it converts pixel data from the YCbCr presentation to the RGB presentation. The inverse coordinates conversion process 230 performs calculations (4) on the components Y, Cb, Cr of pixel data passing through the inverse quantization process 220, thus reproducing the components R, G, B of pixel data.

R=1.164×(Y−16)+1.596×(Cr−128)

G=1.164×(Y−16)−0.391×(Cb−128)−0.813×(Cr−128)

B=1.164×(Y−16)+2.018×(Cb−128) (4)

The color component coupling process 240 is the inverse of the color component separation process 110, wherein it reproduces original data of the RGB presentation based on the components R, G, B of pixel data output from the inverse coordinates conversion process 230.

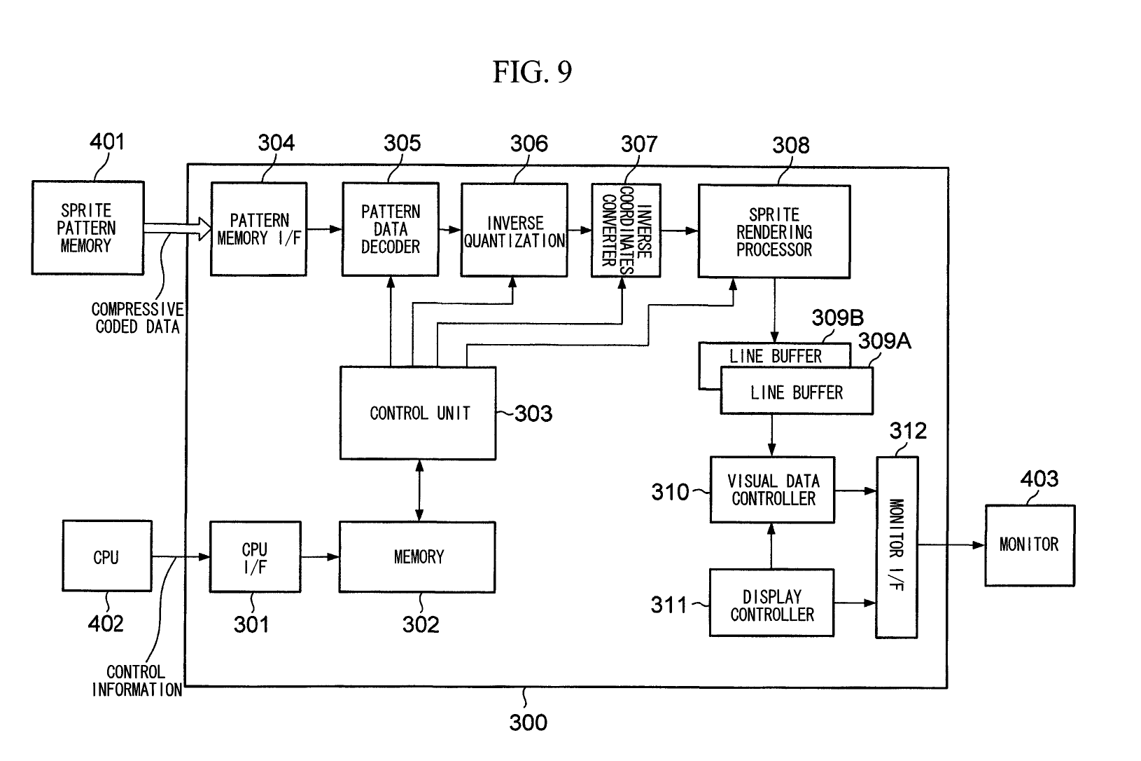

FIG. 9 is a block diagram showing the constitution of a visual processing LSI device 300 having a line-buffer configuration, which is built in a game device, for example. The visual processing LSI device 300 displays sprites such as game characters on screen of a monitor 403 under control of a CPU 402 serving as a control center of a game device. Specifically, reversible compressive coded data are produced by way of the reversible compressive coding (including the predictive coding process 141, the predictive error conversion process 142, and the variable-length coding process 143) on visual data of sprites, while irreversible compressive coded data are produced by way of the irreversible compressive coding (implemented by the compressive coding device 100) on visual data of sprites. Under control of the CPU 402, the visual processing LSI device 300 reads reversible compressive coded data and/or irreversible compressive coded data (both of which may be collectively referred to as compressive coded data) from the sprite pattern memory 401. Compressive coded data are subjected to an adequate decoding procedure corresponding to the reversible compressive coding or the irreversible compressive coding, so that decoding results (i.e. decoded visual data of sprites) are displayed on screen of the monitor 403 in units of lines. In this connection, FIG. 9 shows only the essential parts closely related to the decoding and reproduction of compressive coded data within the entire constitution of the visual processing LSI device 300; hence, it does not show other parts.

The sprite pattern memory 401 is configured of a ROM storing compressive coded data representing plural patterns of sprites, for example.

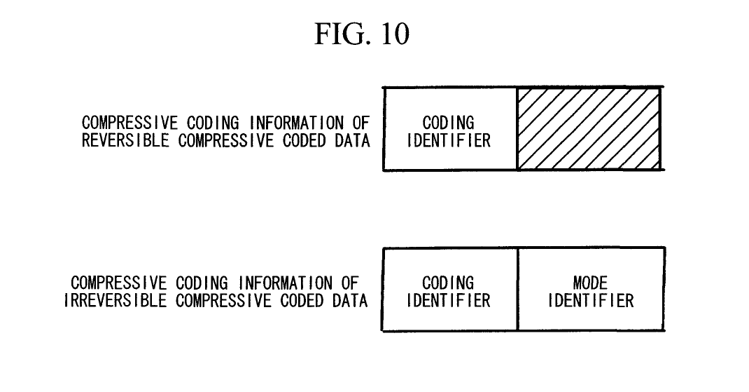

In the visual processing LSI device 300, a CPU interface (or CPU I/F) 301 receives control information from the CPU 402. A memory 302 stores the control information which the CPU 402 supplies via the CPU interface 301. It is configured of a RAM, for example. The control information which the CPU 402 supplies to the memory 302 includes addresses of the sprite pattern memory 401 storing compressive coded data of sprites which are subjected to decoding and reproduction, positions of displaying sprites on screen of the monitor 403, instructions regarding reduction and expansion of sprites, and compressive coding information. As shown in FIG. 10, the compressive coding information includes a coding identifier representing the reversible compressive coding or the irreversible compressive coding with respect to compressive coded data. The compressive coding information representing the irreversible compressive coding further includes a mode identifier representing a quantization mode of the quantization process 133 for producing “irreversible” compressive coded data.

A control unit 303 is a control center that controls the constituent parts of the visual processing LSI device 300 according to the control information stored in the memory 302. Under control of the control unit 303, a pattern memory interface (I/F) 304 accesses compressive coded data stored in areas designated by addresses, included in the control information of the memory 302, in the sprite pattern memory 401. A pattern data decoder 305 implements the foregoing reversible decoding process 210. Under control of the control unit 303, the pattern data decoder 305 reads compressive coded data of sprites from the sprite pattern memory 401 via the pattern memory interface 304. It performs the foregoing variable-length decoding process 211 and the inverse predictive coding process 212 on compressive coded data of sprites. For example, when the pattern data decoder 305 receives reversible compressive coded data from the sprite pattern memory 401, it perfectly reproduce pixel data of the RGB presentation prior to reversible compressive coding by way of the variable-length decoding process 211 and the inverse predictive coding process 212. When the pattern data decoder 305 receives irreversible compressive coded data from the sprite pattern memory 401, it reproduces pixel data of the YCbCr presentation) which are produced by sequentially performing the color component separation process 110, the coordinates conversion process 120, the irreversible conversion process 130, and the quantization process 133 on original visual data of the RGB presentation.

Pixel data of the RGB presentation output from the pattern data decoder 305 are subjected to rendering in a sprite rendering processor 308 so that they are stored in line buffers 309A and 309B in units of lines. Pixel data of the YCbCr presentation output from the pattern data decoder 305 are subjected to an inverse quantization process 306 and an inverse coordinate conversion process 307 and thereby converted into pixel data of the RGB presentation, which are subsequently subjected to rendering in the sprite rendering processor 308. The inverse quantization process 306 performs the foregoing inverse quantization process 220 according to a mode identifier included in the compressive coding information. The inverse coordinates conversion process 307 performs the foregoing inverse coordinates conversion process 220.

Whether the pattern data decoder 305 outputs pixel data of the RGB presentation or pixel data of the YCbCr presentation depends upon whether it receives reversible compressive coded data or irreversible compressive coded data. It is possible to easily make a decision whether reversible compressive coded data or irreversible compressive coded data is subjected to decoding with reference to the compressive coding information stored in the memory 302. When the control unit 303 discriminates reversible compressive coded data upon detecting a coding identifier of the compressive coding information stored in the memory 302, the control unit 303 controls the sprite rendering processor 308 and the line buffers 309A, 309B so as to produce pixel data of sprites in units of lines (i.e. horizontal lines), thus displaying sprites on the screen of the monitor 403. When the control unit 303 discriminates irreversible compressive coded data according to the coding identifier of the compressive coding information, the control unit 303 further controls the inverse quantization process 306 and the inverse coordinates conversion process 307 so as to produce pixel data of sprites in units of lines, thus displaying sprites on the screen of the monitor 403.

Specifically, each of the line buffers 309A and 309B has a capacity of storing one-line of pixel data on screen of the monitor 403. The control unit 303 alternately uses the line buffers 309A and 309B. In a period for displaying one line of pixel data stored in the line buffer 309A on screen of the monitor 403, for example, the control unit 303 has the sprite rendering processor 308 perform rendering for writing the next line of pixel data into the line buffer 309B. In another period for displaying one line of pixel data stored in the line buffer 309B on the screen of the monitor 403, the control unit 303 has the sprite rendering processor 308 perform rendering for writing the next line of pixel data into the line buffer 309A. Under control of the control unit 303, the pattern data decoder 305 (or the pattern data decoder 305, the inverse quantization unit 306, and the display control unit 307) prepares for rending one line of pixel data so that the sprite rendering processor 308 can timely perform rendering. In this case, the control unit 303 accesses the sprite pattern memory 401 to read compressive coded data needed to obtain one line of pixel data with respect to all sprites which should be displayed on the screen of the monitor 403. Subsequently, read compressive coded data are supplied to the pattern data decoder 305 and subjected to decoding.

A visual data controller 310, a display controller 311, and a monitor interface (I/F) 312 read one line of pixel data alternately from the line buffers 309A, 309B and supply them to the monitor 403 so as to display images and graphics on screen. Specifically, the display controller 311 supplies a vertical synchronization signal and a horizontal synchronization signal to the monitor 403 via the monitor interface 312. In addition, it sends a read instruction of pixel data to the visual data controller 310 in synchronization with the horizontal synchronization signal. Upon receiving a read instruction of pixel data, the visual data controller 310 alternately selects the line buffers 309A, 309B so as to read one line of pixel data from the selected line buffer 309 and to send them to the monitor 403 via the monitor interface 312.

The visual processing LSI device 300 of the present embodiment is able to decode both of irreversible compressive coded data and reversible compressive coded data. The constitution of the existing visual processing LSI device decoding reversible compressive coded data can be applied to the visual processing LSI device 300 of the present embodiment except for the inverse quantization process 306 and the inverse coordinates conversion process 307. That is, the visual processing LSI device 300 is designed to maximally utilize the constitution of the existing visual processing LSI device and to thereby achieve decoding on both the irreversible compressive coded data and the reversible compressive coded data.

It is possible to modify the present embodiment by way of the following variations.
(1) In the present embodiment, the sprite pattern memory 401 is able to store both of reversible compressive coded data and irreversible compressive coded data; of course, the sprite pattern memory 401 is used to store only the irreversible compressive coded data so that the compressive coding information does not necessarily include the coding identifier. When the predetermined quantization mode is set to the quantization process 133 needed to produce irreversible compressive coded data, the compressive coding information does not necessarily include the mode identifier. It is possible to store the compressive coding information in the sprite pattern memory 401 in connection with compressive coded data. In this case, the control information (which the CPU 402 sends to the control unit 303) does not necessarily include the compressive coding information.
(2) The present embodiment reduces the number of bits constituting any one of components of pixel data subjected to the reversible compressive coding process 140 by way of the quantization process 133, but the quantization process 133 is not necessarily essential to the present invention; hence, it can be disused. The present embodiment performs the variable-length coding process 143 on the predictive error of the predictive coding process 141 after the predictive error conversion process 142; but it is possible to disuse the predictive error conversion process 142.
(3) In order to minimize the degradation of picture quality owing to the irreversible conversion process 130 (especially, the reduction process 131 and the expansion process 132), the present embodiment performs the coordinates conversion process 120 in mapping pixel data from the RGB presentation to the YCbCr presentation. Instead, it is possible to perform mapping from the RGB presentation to the LUV presentation. In addition, it is possible to employ other types of mapping such as RGB→YUV, RGB→YIQ, RGB→Lab, RGB→HLS, RGB→HSV, RGB→CMY, and RGB→CMYK. As shown in the mapping rule (1), these types of mapping are calculations for producing three components of pixel data of the converted presentation based on the linear combination of pixel data composed of three color components in the original presentation prior to conversion. That is, they calculate three color components of pixel data in the converted presentation based on the linear combination of three color components of pixel data in the original presentation prior to conversion. For example, it is possible to convert the R, G, B components of pixel data into the R-component of pixel data, the difference “G−R” between the G-component and the R-component of pixel data, and the difference “B−R” between the B-component and the R-component of pixel data. Alternatively, it is possible to convert them into the G-component of pixel data, the difference “R−G” between the R-component and the G-component of pixel data, and the difference “B−G” between the B-component and the G-component of pixel data.
(4) Three color components of pixel data in the converted presentation, which are calculated based on the linear combination of three color components of pixel data in the original presentation, are not necessarily above zero; hence, they are possibly set to negative values. The inverse predictive coding process 212 of the present embodiment operates on the precondition that pixel data prior to the predictive coding are above zero; hence, it is inconvenient that “converted” pixel data take negative values. To cope with such a drawback, when converted pixel data output from the coordinates conversion process 120 are likely set to negative values, converted pixel data are subjected to level shifting (by adding a certain positive value or the like) so as to forcibly increase them above zero. In order to prevent the outstanding degradation of picture quality, it is preferable to perform the level shifting prior to the irreversible conversion process 130.
(5) In the present embodiment, the compressive coding device 100 performs the irreversible compressive coding, which is an essential feature of the present invention, by way of the color component separation process 110, the coordinates conversion process 120, the irreversible conversion process 130, and the reversible compressive coding process 140. Needless to say, the compressive coding device 100 can be redesigned to perform only the reversible compressive coding process 140 on pixel data so as to produce reversible compressive coded data. For this reason, the present embodiment can be redesigned such that the compressive coding device 100 selectively performs irreversible compressive coding or reversible compressive coding (i.e. the reversible compressive coding process 140) according to a user's instruction whether to select irreversible compressive coding or reversible compressive coding on pixel data. In such a manner, the compressive coding device 100 is able to produce both reversible compressive coded data and irreversible compressive coded data.
(6) In the present embodiment, an irreversible compressive coding program, which is essential to the present invention, is installed in the compressive coding device 100 in advance. Of course, it is possible to write an irreversible compressive coding program in a computer-readable storage media such as a CD-ROM and to distribute them to users or consumers. Alternatively, it is possible to download the irreversible compressive coding program to users or consumers via telecommunication lines such as the Internet. Similar, it is possible to write a decoding program in a computer-readable storage media, which can be distributed to users or consumers. Alternatively, it is possible to download the decoding program to users or consumers via telecommunication lines.

Lastly, the present invention is not necessarily limited to the present embodiment and variations, which can be further modified in various ways within the scope of the invention as defined in the appended claims.

What is claimed is:

1. A compressive coding device comprising:
a coordinates conversion section which converts pixel data of a first color presentation composed of three color components into pixel data of a second color presentation composed of other three color components;
an irreversible conversion section which performs a reduction process thinning out a prescribed part of pixel data with respect to at least one of three color components of the second color presentation and which performs an expansion process interpolating pixel data so as to restore the prescribed part of pixel data based on a remaining part of pixel data; and
a reversible compressive coding section, which performs a predictive coding process for calculating a predictive value of each pixel data selected in a raster-scanning sequence based on other pixel data positioned close to the selected pixel data, calculates a predictive error representing a difference between the predictive value and an actual value of each pixel data, and performs variable-length coding on the predictive error, thus producing compressed coded data.

2. The compressive coding device according to claim 1, wherein the irreversible conversion section which performs the reduction process and the expansion process such that the predictive error becomes zero alternately with respect to adjacent pixel data which are adjacently aligned on each horizontal scanning line on a screen.

3. The compressive coding device according to claim 1, wherein the irreversible conversion section which performs a quantization process for reducing bits on pixel data already subjected to the reduction process and the expansion process or pixel data not subjected to the reduction process or the expansion process, and wherein the irreversible conversion section which outputs a quantization-mode signal representing a type of pixel data subjected to the quantization process and the number of reduced bits.

4. A decoding device receiving compressive coded data, which are produced by way of a predictive coding process and a variable-length coding process, and a quantization-mode signal representing a type of pixel data subjected to a quantization process and the number of reduced bits owing to the quantization process, comprising:
a reversible decoding section which decodes compressive coded data into pixel data of a second color presentation by way of a variable-length decoding process and an inverse predictive coding process;
an inverse quantization section which interpolates the number of reduced bits included in the type of pixel data designated by the quantization-mode signal with respect to the pixel data of the second color presentation output from the reversible decoding section; and
an inverse coordinates conversion section which reproduces original pixel data of a first color presentation based on the pixel data of the second color presentation passing through the inverse quantization section.
